(19) United States
(12) Patent Application Publication
(10) Pub. No.: US 2025/0150477 A1
(43) Pub. Date: May 8, 2025

(54) NETWORK MONITORING DEVICE, NETWORK MONITORING METHOD, AND RECORDING MEDIUM

(71) Applicant: NEC Corporation, Minato-ku, Tokyo (JP)

(72) Inventors: Noboru Nagatani, Tokyo (JP); Tomoo Adachi, Tokyo (JP); Shuichi Karino, Tokyo (JP)

(73) Assignee: NEC Corporation, Minato-ku, Tokyo (JP)

(21) Appl. No.: 18/835,418

(22) PCT Filed: Mar. 25, 2022
(86) PCT No.: PCT/JP2022/014276

§ 371 Date: Aug. 2, 2024

(51) Int. Cl. H04L 9/40

(52) U.S. Cl. CPC H04L 63/1425; H04L 63/102; H04L 63/1416

(57) ABSTRACT

A network monitoring device according to the present disclosure is provided with an authentication history collection means that collects an authentication history of access to a management function of a network device to be monitored, a statistic calculation means that calculates statistic information of the authentication history, and a display means that displays the statistic information.

### TECHNICAL FIELD

The present disclosure relates to a network monitoring device, a network monitoring method, and a recording medium.

### BACKGROUND ART

The network device usually includes a management function of externally controlling or monitoring a function of the network device, and an administrator remotely accesses the management function. There is a technology for detecting unauthorized access to a network by monitoring access to a management function of a network device.

For example, PTL 1 discloses a technique of comparing access indicated by log information with access for a predetermined process applied in advance, and detecting access that does not match the access for the predetermined process applied in the accesses indicated by the log information as unauthorized access.

### CITATION LIST

### Patent Literature

PTL 1: JP 2020-095750 A

### SUMMARY OF INVENTION

### Technical Problem

However, in the invention described in PTL 1 described above, only access that does not match access for the predetermined process applied in advance is detected as an unauthorized access. However, most unauthorized accesses cannot be detected by this alone.

An object of the present disclosure is to provide a network monitoring device capable of improving detection accuracy of unauthorized access to a network device.

### Solution to Problem

A network monitoring device according to an aspect of the present disclosure includes an authentication history collection means for collecting an authentication history of access to a management function of a network device to be monitored, a statistical value calculation means for calculating statistical value information about the authentication history, and a display means for displaying the statistical value information.

A network monitoring method according to an aspect of the present disclosure includes collecting an authentication history of access to a management function of a network device to be monitored, calculating statistical value information about the authentication history, and displaying the statistical value information.

A recording medium according to an aspect of the present disclosure stores a program for causing a computer to execute the step of collecting an authentication history of access to a management function of a network device to be monitored, calculating statistical value information about the authentication history, and displaying the statistical value information.

### Advantageous Effects of Invention

An example of an effect of the present disclosure is to provide a network monitoring device capable of improving detection accuracy of unauthorized access to a network device.

### BRIEF DESCRIPTION OF DRAWINGS

FIG. 1 is a block diagram illustrating a configuration of a network monitoring device according to the first example embodiment.

FIG. 2 is a diagram illustrating a hardware configuration in which the network monitoring device according to the first example embodiment is implemented by a computer device and its peripheral device.

FIG. 3 is an example of a screen displaying statistical value information in the first example embodiment.

FIG. 4 is another example of a screen displaying statistical value information in the first example embodiment.

FIG. 5 is a flowchart illustrating an operation of network monitoring in the first example embodiment.

FIG. 6 is a block diagram illustrating a configuration of a network monitoring device according to the second example embodiment.

FIG. 7 is an example in which a list of authentication information in an authentication history is displayed in the second example embodiment.

FIG. 8 is another example in which a list of authentication information in an authentication history is displayed in the second example embodiment.

FIG. 9 is a flowchart illustrating an operation of network monitoring in the second example embodiment.

### EXAMPLE EMBODIMENT

An example embodiment will be described in detail with reference to the drawings.

### First Example Embodiment

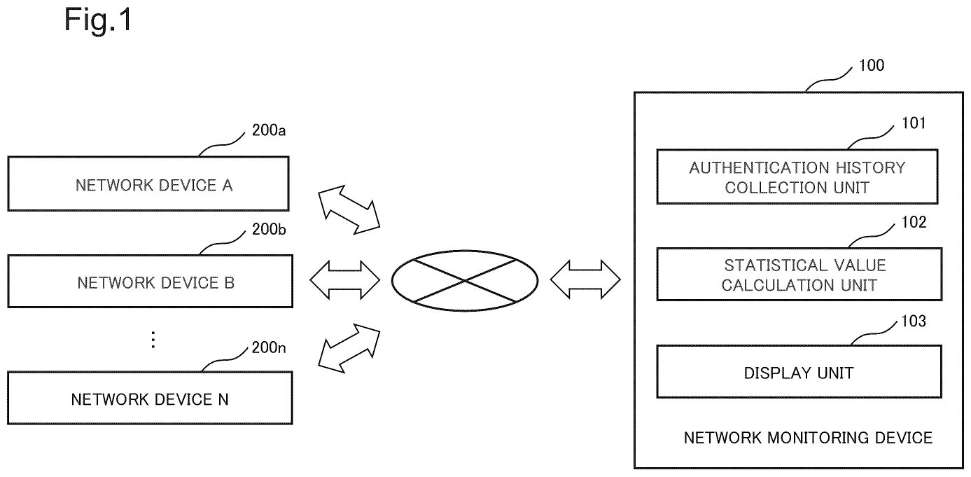

FIG. 1 is a block diagram illustrating a configuration of a network monitoring device 100 according to the first example embodiment. Referring to FIG. 1, the network monitoring device 100 includes an authentication history collection unit 101, a statistical value calculation unit 102, and a display unit 103. Hereinafter, the network monitoring device 100 that is an essential configuration of the present example embodiment will be described in detail.

The network monitoring device 100 collects an authentication history of access to a network device 200 (200a, 200b, . . . , 200n) connected to the network monitoring device 100 via a network, and monitors unauthorized access to the network device 200. Each network device 200 is a device for relaying, transferring, and the like data on a network, and includes a management function of externally controlling or monitoring a function of the device. For access to the management function, login (authentication) is usually set as necessary from the viewpoint of security or the like. Each network device 200 has an authentication function of performing authentication by collating a user name and a password with respect to login from a user, and an authentication history holding function of holding an authentication history. The authentication history is a record of information (authentication information) regarding authentication. The authentication history holding function holds authentication information such as an authentication time, a network device 200 that has performed authentication, access source, an authentication result, and a user name in association with each other.

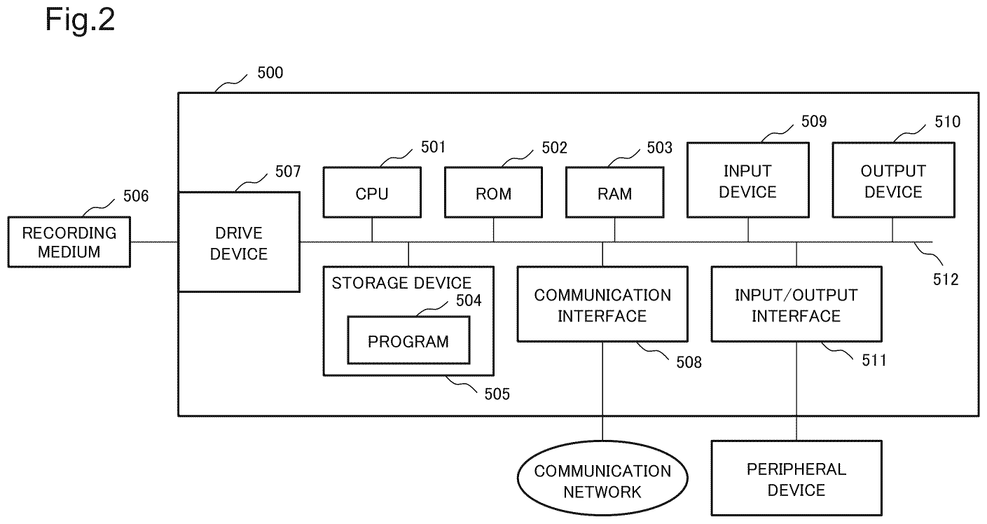

FIG. 2 is a diagram illustrating an example of a hardware configuration in which the network monitoring device 100 according to the first example embodiment of the present disclosure is implemented by a computer device 500 including a processor. As illustrated in FIG. 2, the network monitoring device 100 includes a central processing unit (CPU) 501, a memory such as a read only memory (ROM) 502 and a random access memory (RAM) 503, a storage device 505 such as a hard disk that stores a program 504, a communication interface 508 for network connection, and an input/output interface 511 that inputs and outputs data. In the first example embodiment, the authentication history acquired by the authentication history collection unit 101 is input to the network monitoring device 100 via the communication interface 508.

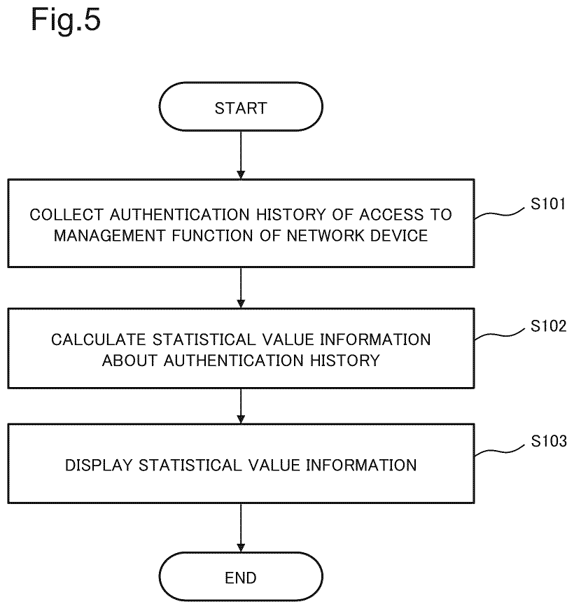

The CPU501 operates an operating system to control the entire network monitoring device 100 according to the first example embodiment of the present invention. The CPU501 reads a program and data from a recording medium 506 attached to a drive device 507 or the like to a memory, for example. The CPU501 functions as the authentication history collection unit 101, the statistical value calculation unit 102, the display unit 103, and part thereof in the first example embodiment, and executes processing or a command in the flowchart illustrated in FIG. 5 to be described later based on a program.

The recording medium 506 is, for example, an optical disk, a flexible disk, a magnetic optical disk, an external hard disk, a semiconductor memory, or the like. A recording medium as part of the storage device is a nonvolatile storage device, and records a program therein. The program may be downloaded from an external computer (not illustrated) connected to a communication network.

An input device 509 is achieved by, for example, a mouse, a keyboard, a built-in key button, and the like, and is used for an input operation. The input device 509 is not limited to a mouse, a keyboard, and a built-in key button, and may be, for example, a touch panel. An output device 510 is achieved by, for example, a display, and is used to check an output.

As described above, the first example embodiment illustrated in FIG. 1 is implemented by the computer hardware illustrated in FIG. 2. However, the means for achieving each unit included in the network monitoring device 100 in FIG. 1 is not limited to the above-described configuration. Furthermore, the network monitoring device 100 may be achieved by one physically coupled device, or may be achieved by a plurality of devices in which two or more physically separated devices are connected in a wired or wireless manner. For example, the input device 509 and the output device 510 may be connected to the computer device 500 via a network. The network monitoring device 100 according to the first example embodiment illustrated in FIG. 1 can also be configured by cloud computing or the like.

In FIG. 1, the authentication history collection unit 101 is a means for collecting an authentication history of access to a management function of the network device 200. The access to the management function of the network device 200 in the present example embodiment is access to the management function described above, and excludes communication processing provided by a function originally provided as the network device 200. The authentication history collection unit 101 acquires an authentication history held in an authentication history holding function of each network device 200 such as a router, a hub, a gateway, or a switch connected to the network. The authentication history is associated with authentication information such as an authentication time, the network device 200 that has performed authentication, an access source, an authentication result, and a user name. The authentication history collection unit 101 outputs the authentication history thus acquired to the statistical value calculation unit 102.

The statistical value calculation unit 102 is a means for calculating statistical value information about the authentication history. The statistical value information is a value obtained by adding authentication results such as the number of times of authentication or the number of successes or the number of failures of authentication in each network device 200 in a predetermined period. The statistical value calculation unit 102 may calculate a ratio of the number of successes or a ratio of the number of failures of authentication to the total number of times of authentication of the network device 200 to be monitored. The predetermined period is not particularly limited, and is, for example, one day or one week. The statistical value calculation unit 102 may calculate a statistical value obtained by adding results by all the network devices 200 to be monitored or a statistical value of each network device 200. The statistical value calculation unit 102 may calculate the transition of the number of successes or the number of failures of authentication for each predetermined period. In this case, it is possible to grasp the temporal change of the attack risk associated with the intrusion into the network device 200. After calculating the statistical value information, the statistical value calculation unit 102 outputs the statistical value information to the display unit 103.

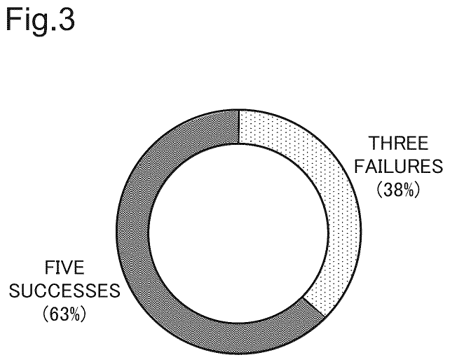

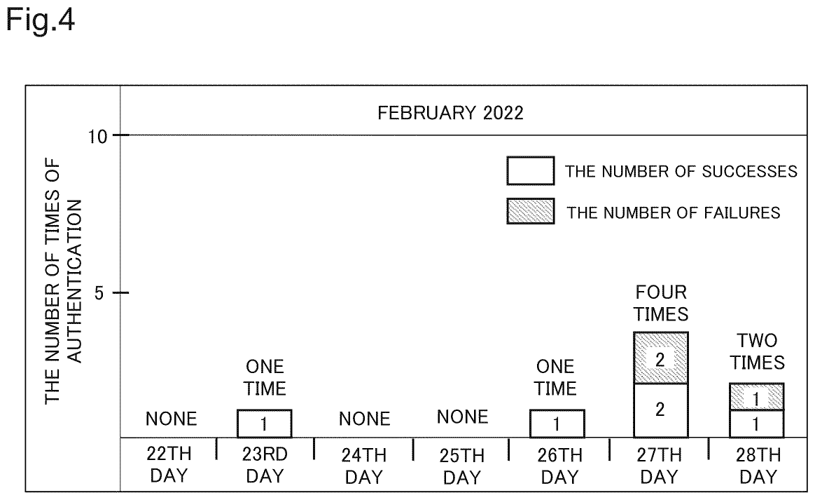

The display unit 103 is a means for displaying the calculated statistical value information. The display unit 103 outputs the statistical value information to the output device 510 and the like. FIG. 3 is an example of a screen displaying statistical value information in the first example embodiment. However, FIG. 3 is an example in which the statistical value information is displayed, and the present invention is not limited to a circular graph. In the example of FIG. 3, the number of successes and the number of failures of authentication in the network device 200 monitored by the network monitoring device 100 in a predetermined period, and the ratio of successes and the ratio of failures with respect to the total number of times of authentication are illustrated. The administrator who manages the network device 200 can estimate that the attack risk associated with the intrusion from the outside is higher as the number of successes of authentication in the network device 200 is smaller and the number of failures of authentication is larger. The display unit 103 may output statistical value information about the number of times of authentication, or the number of successes or the number of failures of authentication per predetermined period in a comparable manner. FIG. 4 is another example of a screen for displaying statistical value information in the first example embodiment. In the example of FIG. 4, a bar graph illustrating the number of times of authentication per day divided into the number of successes and the number of failures is illustrated. In a case where the number of times of authentication or the number of failures rapidly increases in a certain period (for example, several times or more the previous day), the administrator can estimate that there is a possibility of an attack risk from the outside in the period.

The operation of the network monitoring device 100 configured as described above will be described with reference to the flowchart of FIG. 5.

FIG. 5 is a flowchart illustrating an outline of an operation of the network monitoring device 100 according to the first example embodiment. The processing according to this flowchart may be executed based on program control by the processor described above.

As illustrated in FIG. 5, first, the authentication history collection unit 101 collects an authentication history of access to the management function of the network device 200 (step S101). Next, the statistical value calculation unit 102 calculates statistical value information about the authentication history (step S102). Finally, the display unit 103 displays the calculated statistical value information (step S103). Thus, the network monitoring device 100 terminates the operation.

In the network monitoring device 100 according to the first example embodiment, the display unit 103 displays statistical value information about an authentication history of access to a management function of the network device 200. As a result, for example, it is possible to grasp the possibility of unauthorized access to the network device 200 based on the authentication result such as the number of times of authentication to the network device 200, the number of successes, the number of failures, or the like of authentication. Therefore, even access other than the access applied in advance can be detected as unauthorized access, and the detection accuracy of unauthorized access to the network device 200 can be enhanced.

### Second Example Embodiment

Next, the second example embodiment of the present disclosure will be described in detail with reference to the drawings. Hereinafter, description of content overlapping with the above description will be omitted to the extent that the description of the present example embodiment is not unclear. As in the computer device illustrated in FIG. 2, each component in each example embodiment of the present disclosure can be achieved not only by hardware but also by a computer device or software based on program control.

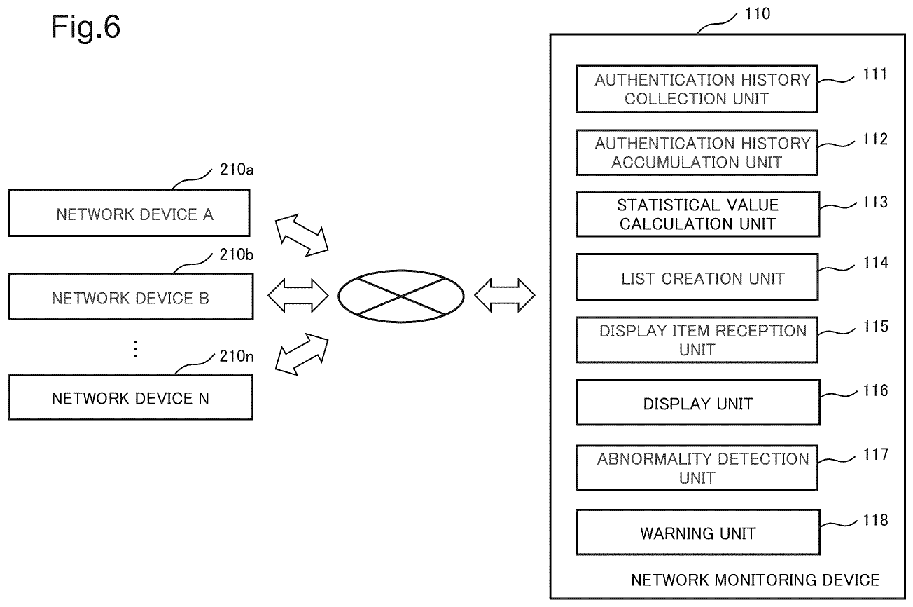

FIG. 6 is a block diagram illustrating a configuration of a network monitoring device 110 according to the second example embodiment of the present disclosure. With reference to FIG. 6, the network monitoring device 100 will be described focusing on portions different from those of the network monitoring device 110 according to the first example embodiment.

The network monitoring device 110 according to the second example embodiment includes an authentication history collection unit 111, an authentication history accumulation unit 112, a statistical value calculation unit 113, a list creation unit 114, a display item reception unit 115, a display unit 116, an abnormality detection unit 117, and a warning unit 118. The authentication history accumulation unit 112 is a means for accumulating the authentication history for each network device 210 collected by the authentication history collection unit 111. Since the authentication history collection unit 111 and the statistical value calculation unit 113 are similar to the authentication history collection unit 101 and the statistical value calculation unit 102 in the first example embodiment, the description thereof is omitted here.

The list creation unit 114 is a means for creating a list of authentication information about authentication histories in a predetermined period. The list collectively displays the authentication information in the authentication history, and the authentication information includes an authentication time, a network device 210 that has performed the authentication, an access source, an authentication result, a user name, an access means, an authentication result, an authentication failure reason, and the like. Examples of the access means include a console and a vty (Virtual Teletype), and may include ssh (Secure Shell), telnet (Teletype Network), and the like as a communication protocol used for accessing the vty.

The list creation unit 114 may create a list by arranging pieces of the authentication information in order of the authentication time. The list creation unit 114 may create a list by extracting only an authentication history meeting a predetermined condition from the authentication histories accumulated in the authentication history accumulation unit 112. In a case where access to a specific network device 210 such as maintenance work is scheduled, the list creation unit 114 may create a list of authentication histories associated with the scheduled access. In this case, the list creation unit 114 extracts the authentication history including the authentication history in the time zone of the maintenance work and the user name who is scheduled to make access.

The display item reception unit 115 is a means for receiving selection of a display item of the authentication information to be displayed. For example, the display item reception unit 115 receives the display items to be displayed in the list in the authentication information through the input device 509. The display items include at least information about the authenticated network device 210, access source information such as an IP address, an authentication result, and a failure reason in a case where the authentication fails.

The display unit 116 displays the list created by the list creation unit 114 on the output device 510 or the like. In a case where receiving the display item displayed by the display item reception unit 115, the display unit 116 displays only the received display item.

The abnormality detection unit 117 is a means for detecting an abnormality in a case where the abnormality is found in the statistical value information or the authentication history. For example, the abnormality detection unit 117 detects the abnormality in a case where the number of times of authentication or the number of failures rapidly increases in a certain period in the statistical value information calculated in each predetermined period. The case where the number of times of authentication or the number of failures rapidly increases is, for example, a case where the number of times of authentication or the number of failures increases several times or more as compared with that in the immediately preceding period. The abnormality detection unit 117 may detect an abnormality in a case where access to a plurality of the network devices 210 is attempted. The abnormality detection unit 117 may detect an abnormality in a case where the abnormality is found in the authentication history in the created list. The abnormality detection unit 117 detects an abnormality, for example, in a case where a user name or a password is different for each network device 210 and an authentication history in which authentication has failed is included. The abnormality detection unit 117 may detect an abnormality in a case where authentication is tried in a use time different from a normal use time. Furthermore, the abnormality detection unit 117 may detect an abnormality in a case where an authentication history of a user who has not logged in for a predetermined period (for example, one month or more) or an authentication history of a user who has logged in for the first time is included.

When the list creation unit 114 creates a list of authentication histories related to scheduled accesses, the abnormality detection unit 117 detects an abnormality in a case where the created list includes an authentication history different from the scheduled authentication history. For example, the abnormality detection unit 117 detects an abnormality in a case where an authentication history of a user name who is scheduled to make access in a time zone different from the scheduled time zone or an authentication history from a user different from the user name who is scheduled to make access in the scheduled time zone.

The warning unit 118 is a means for warning the administrator in a case where an abnormality is detected. The warning unit 118 outputs the authentication history in which the abnormality is detected to the output device 510 such as a display device. In this case, the warning unit 118 may highlight the corresponding authentication history in the list displayed by the display unit 116 by coloring or the like.

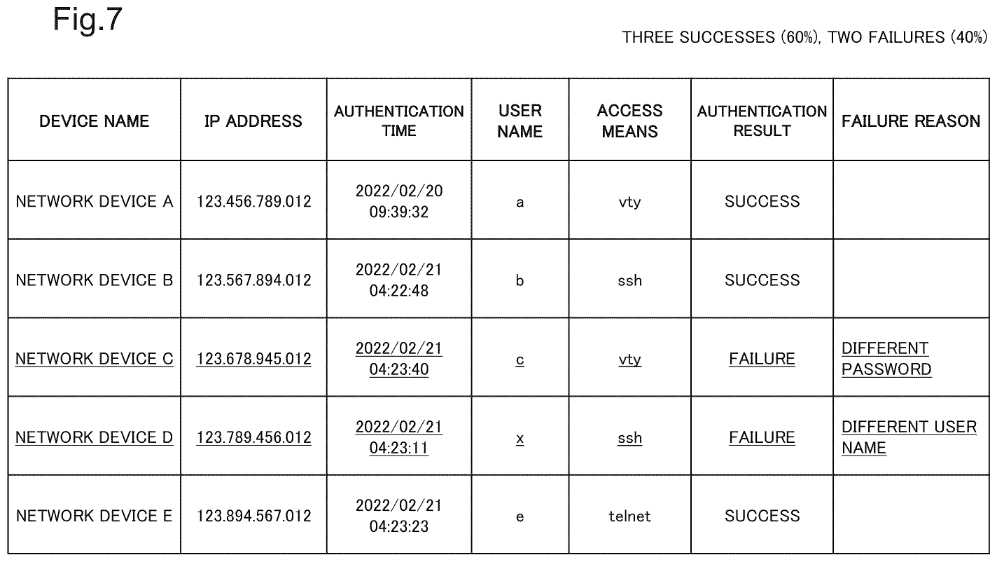

A method of detecting an abnormality by the network monitoring device 110 will be described in detail with reference to the drawings. FIG. 7 illustrates an example in which a list of authentication information in an authentication history is displayed in the second example embodiment. As illustrated in FIG. 7, the network device name, the IP address, the authentication time, the user name, the access means, the authentication result, and the authentication failure reason are displayed as the authentication information about the authentication history. In the example of FIG. 7, the network device C received an incorrect input password, and the network device D received an incorrect user name. In this case, the abnormality detection unit 117 detects an abnormality in the authentication history for the network device C and the network device D, and the warning unit 118 warns the administrator. In this case, as illustrated in FIG. 7, the warning unit 118 may underline and highlight the authentication histories of the network device C and the network device D on the list displayed by the display unit 116. As illustrated in FIG. 7, the display unit 116 may display the statistical value information about the authentication history together with the list of the authentication information about the authentication history.

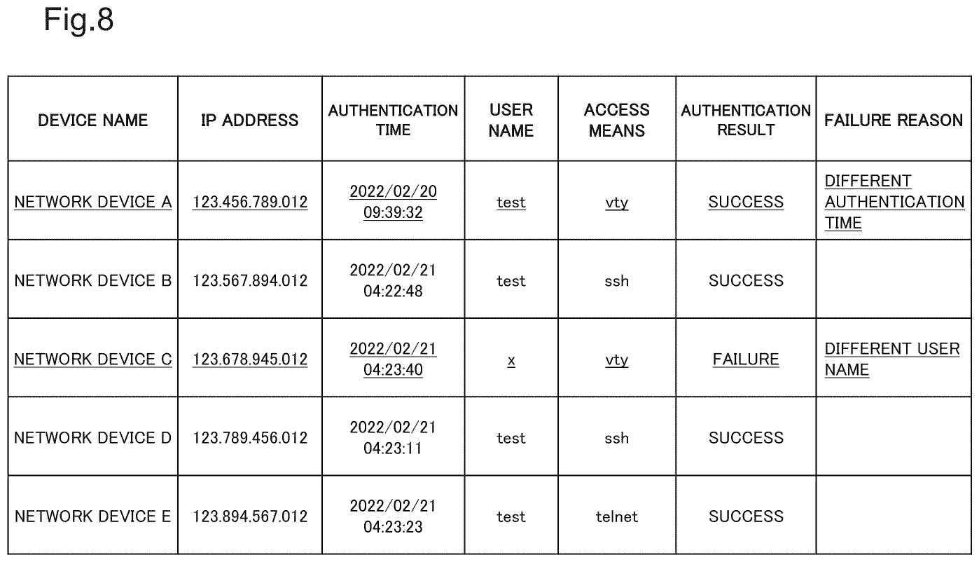

FIG. 8 is another example in which a list of authentication information in an authentication history is displayed in the second example embodiment. FIG. 8 illustrates an example in which the list creation unit 114 creates a list of authentication histories related to scheduled accesses. In the example of FIG. 8, it is assumed that access from a user name “test” is scheduled at 4:00 to 4:30 on Feb. 21, 2022. In the list of the authentication histories in FIG. 8, the authentication time of the network device A is different from the scheduled time zone, and the user name of the network device C is incorrect. In this case, the abnormality detection unit 117 detects an abnormality in the authentication history for the network device C and the network device D. As illustrated in FIG. 8, the warning unit 118 underlines and highlights the authentication histories of the network device A and the network device C on the list displayed by the display unit 116.

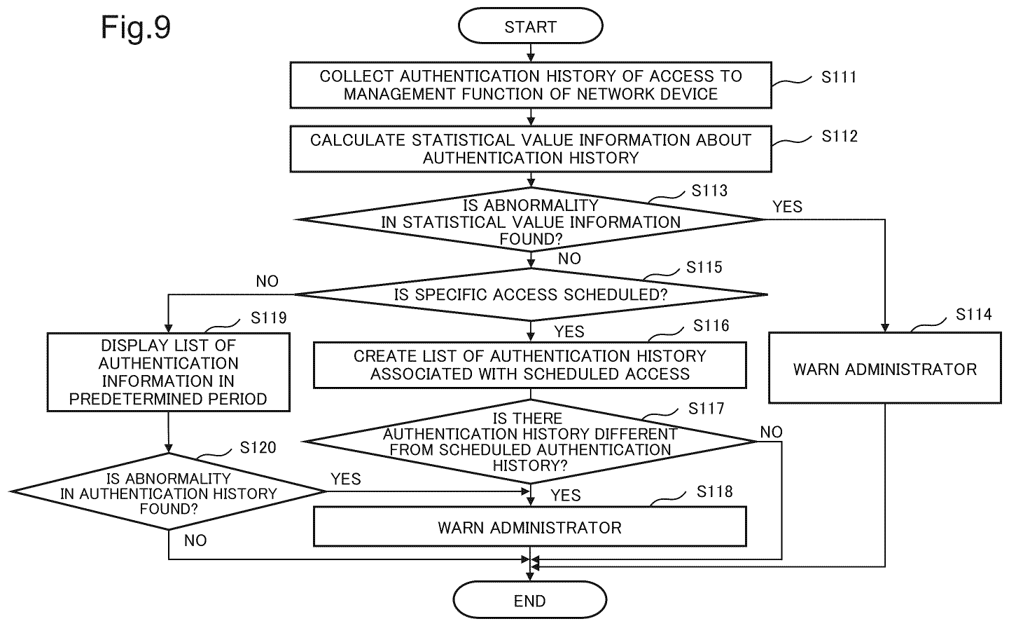

The operation of the network monitoring device 110 configured as described above will be described with reference to the flowchart of FIG. 9.

FIG. 9 is a flowchart illustrating an outline of an operation of the network monitoring device 110 according to the second example embodiment. The processing according to this flowchart may be executed based on program control by the processor described above.

As illustrated in FIG. 9, first, the authentication history collection unit 111 collects an authentication history of access to the management function of the network device 210 (step S111). Next, the statistical value calculation unit 113 calculates statistical value information about the authentication history (step S112). In a case where an abnormality is found in the statistical value information (S113; YES), the abnormality detection unit 117 detects the abnormality, the warning unit 118 warns the administrator (step S114), and ends the process. On the other hand, in a case where no abnormality is found in the statistical value information (step S113; NO), the abnormality detection unit 117 advances the process to step S115. Next, in a case where access to a specific network device 210 such as for maintenance work is scheduled (step S115; YES) the list creation unit 114 creates a list of authentication histories associated with the scheduled access (step S116). Next, in a case where an authentication history different from the scheduled authentication history is included in the created list (step S117; YES), the abnormality detection unit 117 detects the abnormality, and the warning unit 118 warns the administrator (step S118). On the other hand, in a case where the created list does not include an authentication history different from the scheduled authentication history (step S117; NO) and the abnormality detection unit 117 ends the process.

In step S115, in a case where access to a specific network device 210 such as for maintenance work is not scheduled (step S115; NO), the list creation unit 114 creates a list of authentication histories in a predetermined period (step S119). Next, in a case where an abnormality is found in the authentication history in the created list (step S120; YES), the abnormality detection unit 117 detects the abnormality, and the warning unit 118 warns the administrator (step S118). On the other hand, in a case where no abnormality is found in the authentication history in the created list (step S120; NO) and the abnormality detection unit 117 ends the process. Thus, the network monitoring device 110 terminates the operation.

In the network monitoring device 110 according to the second example embodiment of the present disclosure, in a case where an abnormality is found in the statistical value information or the authentication history in the created list, the abnormality detection unit 117 detects the abnormality, and the warning unit 118 warns the administrator. As a result, in a case where an abnormality is found in the statistical value information or the authentication history, it is possible to make a notification to the administrator. In the network monitoring device 110, the abnormality detection unit 117 detects an abnormality in a case where an authentication history of a user who has not logged in for a predetermined period or an authentication history of a user who has logged in for the first time is included. Further, in a case where the created list includes an authentication history different from the scheduled authentication history, the abnormality detection unit 117 detects an abnormality. As a result, even in a case where the authentication is successful, it is possible to detect a possibility of an attack using the proper authentication information.

While the present invention is described with reference to example embodiments thereof, the present invention is not limited to the above example embodiments. Various modifications that can be understood by those of ordinary skill in the art can be made to the configuration and details of the present invention within the scope of the present invention.

For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

Some or all of the above example embodiments may be described as the following Supplementary Notes, but are not limited to the following.

### Supplementary Note 1

A network monitoring device including
an authentication history collection means for collecting an authentication history of access to a management function of a network device to be monitored,
a statistical value calculation means for calculating statistical value information about the authentication history, and
a display means for displaying the statistical value information.

### Supplementary Note 2

The network monitoring device according to Supplementary Note 1, wherein
the statistical value calculation means calculates the number of successes or the number of failures of authentication in the network device in a predetermined period based on the authentication history.

### Supplementary Note 3

The network monitoring device according to Supplementary Note 1 or 2, further including
a list creation means for creating a list of authentication information about the authentication history in a predetermined period, wherein
the display means displays the list together with the statistical value information.

### Supplementary Note 4

The network monitoring device according to Supplementary Note 3, wherein
the list creation means creates a list by arranging pieces of the authentication information in order of authentication time.

### Supplementary Note 5

The network monitoring device according to Supplementary Note 3 or 4, wherein
in a case where access to a specific network device is scheduled, the list creation means creates a list of authentication histories associated with the scheduled access.

### Supplementary Note 6

The network monitoring device according to any one of Supplementary Notes 1 to 5, further including
an abnormality detection means for detecting an abnormality in a case where the abnormality is found in statistical value information or an authentication history, and
a warning means for warning an administrator in a case where the abnormality is detected.

### Supplementary Note 7

The network monitoring device according to Supplementary Note 6, wherein
the statistical value calculation means calculates a statistical value information every predetermined period, and
the abnormality detection means detects an abnormality in a case where the number of times of authentication or the number of failures rapidly increases.

### Supplementary Note 8

The network monitoring device according to Supplementary Note 6, wherein
the abnormality detection means detects an abnormality in a case where access to a plurality of network devices is attempted.

### Supplementary Note 9

The network monitoring device according to Supplementary Note 6, wherein
the abnormality detection means detects an abnormality in a case where an authentication history of a user who has not logged in for a predetermined period or an authentication history of a user who has logged in for the first time is included.

### Supplementary Note 10

The network monitoring device according to Supplementary Note 6, wherein
the abnormality detection means detects an abnormality in a case where an authentication history different from a scheduled authentication history is included.

### Supplementary Note 11

A network monitoring method including
collecting an authentication history of access to a management function of a network device to be monitored, calculating statistical value information about the authentication history, and
displaying the statistical value information.

### Supplementary Note 12

A recording medium storing a program for causing a computer to execute the step of
collecting an authentication history of access to a management function of a network device to be monitored, calculating statistical value information about the authentication history, and
displaying the statistical value information.

### REFERENCE SIGNS LIST

100, 110 network monitoring device
101, 111 authentication history collection unit
102, 113 statistical value calculation unit
103, 116 display unit
112 authentication history accumulation unit
114 list creation unit
115 display item reception unit
117 abnormality detection unit
118 warning unit
200, 210 network device

What is claimed is:

1. A network monitoring device comprising:
a memory storing instructions; and
at least one processor configured to execute the instructions to:
collect an authentication history of access to a management function of a network device to be monitored;
calculate statistical value information about the authentication history; and
display the statistical value information.

2. The network monitoring device according to claim 1, wherein the at least one first processor is further configured to execute the instructions to:
calculate the number of successes or the number of failures of authentication in the network device in a predetermined period based on the authentication history.

3. The network monitoring device according to claim 1, wherein the at least one first processor is further configured to execute the instructions to:
create a list of authentication information about the authentication history in a predetermined period; and
display the list together with the statistical value information.

4. The network monitoring device according to claim 3, wherein the at least one first processor is further configured to execute the instructions to:
create a list by arranging pieces of the authentication information in order of authentication time.

5. The network monitoring device according to claim 3, wherein the at least one first processor is further configured to execute the instructions to:
in a case where access to a specific network device is scheduled, create a list of authentication histories associated with the scheduled access.

6. The network monitoring device according to claim 1, wherein the at least one first processor is further configured to execute the instructions to:
detect an abnormality in a case where the abnormality is found in statistical value information or an authentication history; and
warn an administrator in a case where the abnormality is detected.

7. The network monitoring device according to claim 6, wherein the at least one first processor is further configured to execute the instructions to:
calculate a statistical value information every predetermined period; and
detect an abnormality in a case where the number of times of authentication or the number of failures rapidly increases.

8. The network monitoring device according to claim 6, wherein the at least one first processor is further configured to execute the instructions to:
detect an abnormality in a case where access to a plurality of network devices is attempted.

9. The network monitoring device according to claim 6, wherein the at least one first processor is further configured to execute the instructions to:
detect an abnormality in a case where an authentication history of a user who has not logged in for a predetermined period or an authentication history of a user who has logged in for the first time is included.

10. The network monitoring device according to claim 6, wherein the at least one first processor is further configured to execute the instructions to:
detect an abnormality in a case where an authentication history different from a scheduled authentication history is included.

11. A network monitoring method comprising:
collecting an authentication history of access to a management function of a network device to be monitored;
calculating statistical value information about the authentication history; and
displaying the statistical value information.

12. A non-transitory recording medium storing a program for causing a computer to execute the step of:
collecting an authentication history of access to a management function of a network device to be monitored;
calculating statistical value information about the authentication history; and
displaying the statistical value information.
